(19) United States
(12) Patent Application Publication
(10) Pub. No.: US 2006/0001921 A1
(43) Pub. Date: Jan. 5, 2006

(54) System and method for high-performance scanner calibration

(76) Inventors: James R. Bailey, Shelbyville, KY (US); Curt P. Breswick, Georgetown, KY (US); David A. Crutchfield, Georgetown, KY (US); Joseph K. Yackzan, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/883,427

(22) Filed: Jun. 30, 2004

(51) Int. Cl. H04N 1/46

(52) U.S. Cl. 358/504

(57) ABSTRACT

The present invention is directed to a system and method for reducing the memory requirement for offset and gain calibration to relieve the size/performance bottleneck in scanner systems. The resulting methodology produces visually equivalent scanned results with a substantial increase in performance, which results in a shorter amount of time required to output a first copy in, for example, an all-in-one device. Since the calibration step is often the bottleneck in scanner performance, this method noticeably speeds up scan and copy time. Implementing the decompression in hardware requires a minimal amount of hardware overhead and complexity. Thus, this method has a minimal impact on the size and cost of the scanner controller (e.g., an ASIC—application specific integrated circuit). Since compression only takes place at most once per scan, this added step has no significant impact on the overall scan time. By allowing dynamic grouping of pixels using a single calibration packet, the quality of the compensation can be optimized with the size of the compensation data being minimized. Adding the ability to shift the compressed deviation stored in the calibration packet, the range of the pixel-to-pixel deviation can be increased without impacting the size of the calibration data. This flexibility makes this invention applicable to future image sensors that may have widely varying deviations in pixel-to-pixel offset and gain values.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND OF THE INVENTION

1. Field of the Invention

The present invention generally relates to the calibration of scanning systems, such as those found in host-based scanners, all-in-one (AIO) devices, and the like.

2. Description of the Related Art

When scanning an image using a host-based scanner or multi-functional device such as an all-in-one (AIO), it is necessary to compensate for imperfections in the scanning system in order to accurately reproduce the target image. Two characteristics of CCD based image sensors contained in scanners that require such compensation are dark signal non-uniformity (DSNU) and photo response non-uniformity (PRNU). DSNU refers to the pixel-to-pixel variation in a CCD array to the detected black level or zero light present level. PRNU refers to the pixel-to-pixel variation in a CCD array to the detected white level or fixed intensity light level. Failure to properly compensate for these imperfections results in visual artifacts such as vertical streaking and parasitic light areas in dark regions of the reproduced image.

Several methods exist to compensate for PRNU and DSNU. For DSNU, an offset value can be recorded for each pixel (CCD element) during calibration by taking a sample scan with the light off or by scanning a black calibration strip. The recorded offset values, commonly known as black-level offsets, can then be subtracted off of each incoming pixel to properly adjust the black level of each pixel. For optimal quality, this operation can be performed pixel-to-pixel on the analog representation of the pixel before it is digitized. To increase performance and reduce system cost/complexity, this pixel-to-pixel compensation can be performed after digitization at the expense of some quality. Some scanners apply a single average offset to all pixels to further minimize cost/complexity and maximize performance. For PRNU, a gain value can be recorded for each pixel during calibration by scanning a white calibration strip. The recorded gain values, commonly known as white-level gains, can then be used to multiply each incoming pixel by the appropriate gain factor to stretch the output to the appropriate intensity level. As with DSNU compensation, this can be performed pixel-to-pixel in the analog or digital domain with some systems performing a universal gain on all pixels at the expense of quality.

Performing these pixel-to-pixel corrections in the analog domain is often unrealistic for today's end-user scanners due to the cost and performance constraints of these products. It is common to utilize a single average offset and a single average gain for all pixels in the analog domain to maximize the dynamic range of the A/D converter in the scanner's analog front-end (AFE). This is often followed by pixel-to-pixel corrections in the digital domain to correct for the CCD element variations. Lower quality scanners bypass the pixel-to-pixel correction altogether because of cost and performance limitations. A 9″ wide 600-ppi scanner will require 5400 offset and gain values per color (red, green, and blue) to be stored during calibration and used for each incoming scan line. If each offset and gain value is one byte each, this results in over 31 KB of data that must be stored and applied to each incoming scan line. This often becomes the performance bottleneck in scanners, especially in all-in-one devices where the scan data must be processed to print data during a copy. In such devices, a tremendous amount of data must be pushed into and out of a single memory to complete a scan-to-print operation. Requiring 31 KB of data to be read from main memory for each scan line can limit scan and print speed due to the amount of memory bandwidth required. Utilizing a local memory to store the calibration data can increase the cost of the ASIC substantially due to the size of such a memory. This requirement increases as scan resolution increases making the problem worse as scanner technology advances.

### SUMMARY OF THE INVENTION

The present invention is directed to a system and method for reducing the memory requirement for offset and gain calibration to relieve the size/performance bottleneck in scanner systems. The resulting methodology produces visually equivalent scanned results with a substantial increase in performance, which results in a shorter amount of time required to output a first copy in, for example, an all-in-one device.

Specifically, the present invention includes a method for reducing the scanner calibration data from, in one embodiment, 33% to 83% in size. The resulting image is visually equivalent to a scanned image compensated with non-compressed scanner calibration data. Since the calibration step is often the bottleneck in scanner performance, this method noticeably speeds up scan and copy time. Implementing the decompression in hardware requires a minimal amount of hardware overhead and complexity. Thus, this method has a minimal impact on the size and cost of the scanner controller (e.g., ASIC—application specific integrated circuit). Since compression only takes place at most once per scan, this added step has no significant impact on the overall scan time. By allowing dynamic grouping of pixels using a single calibration packet, the quality of the compensation can be optimized with the size of the compensation data being minimized. By adding the ability to shift the compressed deviation stored in the calibration packet, the range of the pixel-to-pixel deviation can be increased without impacting the size of the calibration data. This flexibility makes this invention applicable to future image sensors that may have widely varying deviations in pixel-to-pixel offset and gain values.

These and other aspects will become apparent from the following description of the invention, although variations and modifications may be effected without departing from the spirit and scope of the novel concepts of the present disclosure.

### BRIEF DESCRIPTION OF THE DRAWINGS

FIG. 1 illustrates a block diagram of an optical reduction scanner.

FIG. 2 illustrates three rows of elements typically found in an image sensor within a scanner.

FIG. 3 illustrates a block diagram for a contact image sensor (CIS) scanner.

FIG. 4 illustrates a prior art flow diagram for calibrating a scanner.

FIG. 5 illustrates sample set of calibration data for a scan.

FIG. 6 illustrates the composition of a calibration packet, in one embodiment.

FIG. 7 illustrates another sample set of calibration data for a scan.

FIG. 8 illustrates a flow diagram for calibrating a scanner, according to the teachings of the present invention.

### DETAILED DESCRIPTION OF THE INVENTION

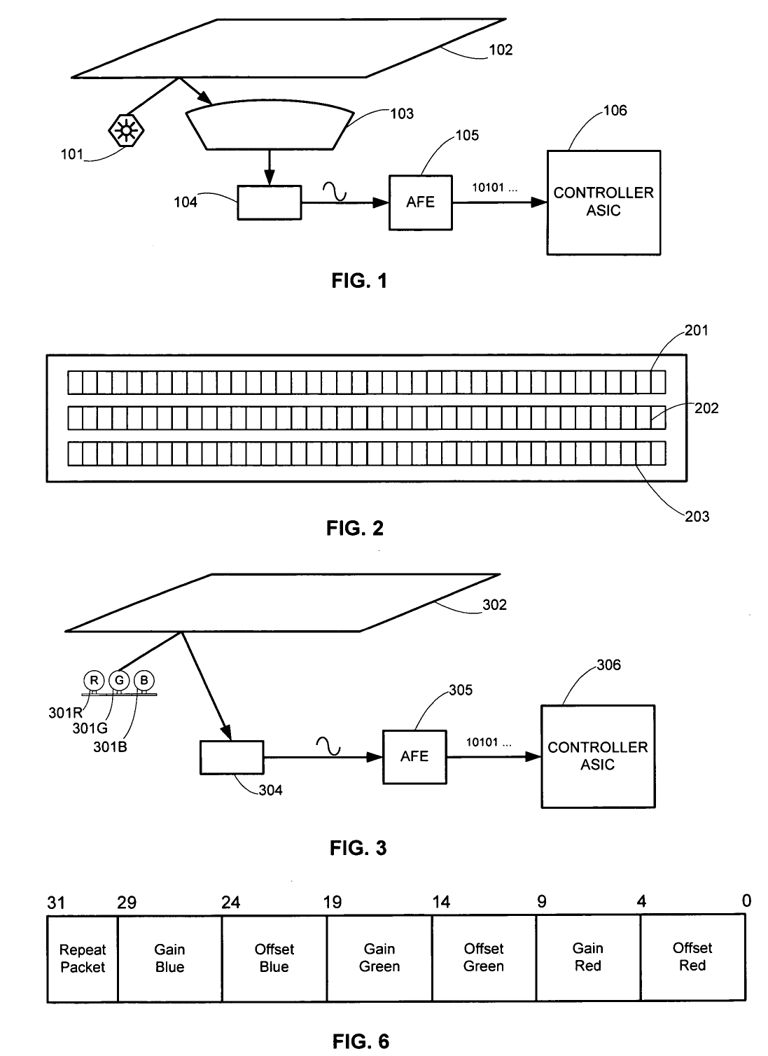

FIG. 1 shows a basic block diagram for an optical reduction scanner (which is often incorrectly labeled a CCD scanner). Charge coupled device (CCD) elements refer to the technology of the image sensor, in one embodiment. CCD image sensors have historically been used with optical reduction scanners, hence the confusion. The following is an explanation of the basic operation of this type of scanner. Of course, it will be readily understood that the present invention may be used with a wide variety of scanners.

A white light source 101 such as a fluorescent bulb is used to illuminate a line of the target image 102. This type of light source contains the red, green, and blue wavelengths of light. The light reflects off of the target image and is directed through a series of optical elements 103 that shrink the image down to the size of the small image sensor 104.

The image sensor 104 typically contains three rows of elements. As shown in FIG. 2, each row (201, 202 and 203) has a filter placed on it to detect a certain color, usually red, green, and blue. The image sensor 104 charges up to a certain voltage level corresponding to the intensity of the color detected for that element. The more color light that exposes the element, the higher or lower the voltage level depending on if the sensor is a positive or negative going signal. The voltage for each element for the captured line is then shifted out of the image sensor serially and sent to an analog front end (AFE) device 105, which contains an analog to digital (A/D) converter. The analog voltage is then converted to a digital value and sent to the digital controller ASIC 106 where it is then processed and sent to the host PC for a scan-to-host operation, or sent to a printer for a standalone copy operation.

Today's scanners typically capture 36 to 48-bits of digital data from the AFE 105 then convert this down to a 24-bit image. The other piece of the scanner not shown in FIG. 1 is the scanner motor, which moves the light source, optics, and sensor to the next line of the target image.

FIG. 3 shows a block diagram for a contact image sensor (CIS) scanner. This type of scanner has no optics to reduce the incoming light down to the image sensor. Instead, the image sensor extends to the width of the scanner target area. Unlike optical reduction scanners, this type of scanner has very little depth-of-field capture, meaning that the target must be very close to the image sensor in order to be captured. The following is an explanation for the basic operation of this type of scanner.

One of the three light sources, red 301R, green 301G, or blue 301B, is turned on exposing the target image 302 to that particular wavelength of light. The light bounces off of the target image 302 and exposes a single line of image sensors 304. This sensor 304 has no color filter on it, so it is used for all three light sources. The sensor 304 charges up and is shifted into the AFE 305 where it is digitized and sent to a controller ASIC 306. The next light source turns on and the process repeats.

Note that three scans are required for each line corresponding to turning on each light source one at a time. For optical reduction scanners, one scan is required for each line since there is a single white light source and three filtered image sensor lines.

The AFE typically contains calibration values to set the analog white and black point to the A/D converter. This may be a single value for offset and a single value for gain that is applied to every pixel in the line (usually, there is a unique offset and gain value for each color resulting in 6 total values). This is done to maximize the dynamic range of the A/D converter. The digital controller ASIC typically contains access to pixel-to-pixel calibration values for the digital white and black points for each pixel in a line. This step corrects for the non-uniformity of the image sensors/optics/illumination from pixel-to-pixel to normalize the captured line response. The pixel-to-pixel calibration values for the digital white and black points are one of the aspects of the present scanner calibration invention.

The following paragraphs describe in further detail a method for reducing the amount of data that must be stored into memory for performing visually equivalent photo response non-uniformity (PRNU) and dark signal non-uniformity (DSNU) compensation pixel-to-pixel after digitization of the scan data.

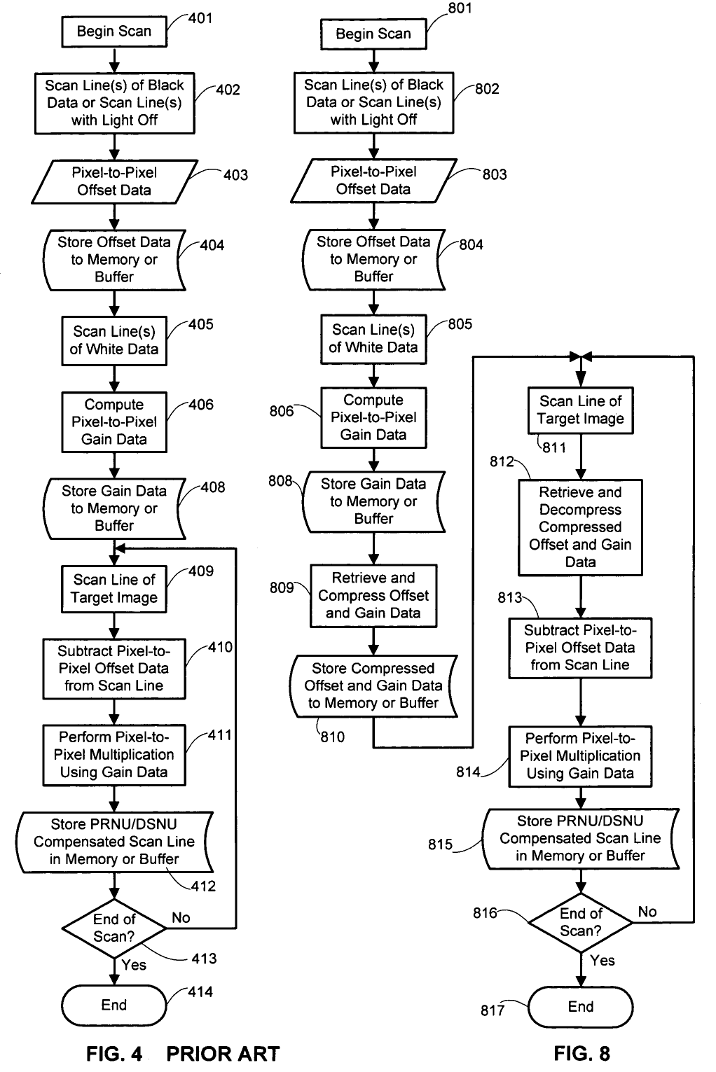

An example prior art flow diagram for calibrating a scanner to compensate for PRNU and DSNU and applying the compensation for DSNU and PRNU is shown in FIG. 4. With reference to FIG. 4, the following steps are performed.

Beginning with step 401, the scan begins. In step 402, one or more lines of black data or one or more lines with the light off are scanned. In step 403, pixel-to-pixel offset data are calculated and stored to memory in step 404. In some cases, a calculation of this offset data is not required because, for example, if a black line is being scanned and if the scanned data is expected to have value of 0 but instead has a value of 2 then the offset becomes the scanned value or, in this example, 2. In step 405, one or more lines of white data are scanned. In step 406, pixel-to-pixel gain data are computed, and stored to memory or a buffer in step 408.

In step 409, a line of the target image is scanned, and in step 410, the pixel-to-pixel offset data is subtracted from the scanned line of the target image. In step 411, pixel-to-pixel multiplication using the gain data is performed on the scanned line of the target image. In step 412, a PRNU/DSNU compensated scan line results from steps 410 and 411 and it is stored to memory or a buffer. In step 413 a determination is made to see if the end of the scanned image has been reached. If the scan of the target image is not complete, then the process is repeated beginning at step 409 for each of the remaining scan lines of the target image. If the scan is complete, the process ends at step 414.

Notice that for each scan line, the pixel-to-pixel offset and gain data is applied during the compensation steps. If the offset and gain data is stored in main memory, it must be read from memory once for each line that is scanned in. This operation consumes an enormous amount of memory bandwidth, which affects the overall performance of the device. In some embodiments, this step can be the performance bottleneck in all-in-one controller ASICs that are used to perform standalone copy operations.

An internal buffer can be utilized to reduce the memory bandwidth that the compensation operation consumes. However, traditional offset and gain data is substantial in size requiring a very large buffer. The size of this buffer often exceeds the size and cost constraints for a scanner controller ASIC.

Using traditional techniques, the offset and gain data that is stored to memory corresponds to one to two bytes of offset data plus one to two bytes of gain data per pixel for an entire scan line. Each pixel is comprised of three colors: red, green, and blue. For a 9″ 600-ppi scanner, this corresponds to (9 inches)*(600 pixels/inch)*(3 colors/pixel)*(1 to 2 bytes offset data +1 to 2 bytes gain data)=31 KB to 62 KB of compensation data. If the scanner data is truncated to 24-bit pixels before being stored to memory, the compensation data will be two to four times as large as the output scan line that is written to memory. Thus, reading in the compensation data from memory will consume significantly more memory bandwidth than writing out the scan line to memory, making PRNU/DSNU compensation the performance bottleneck.

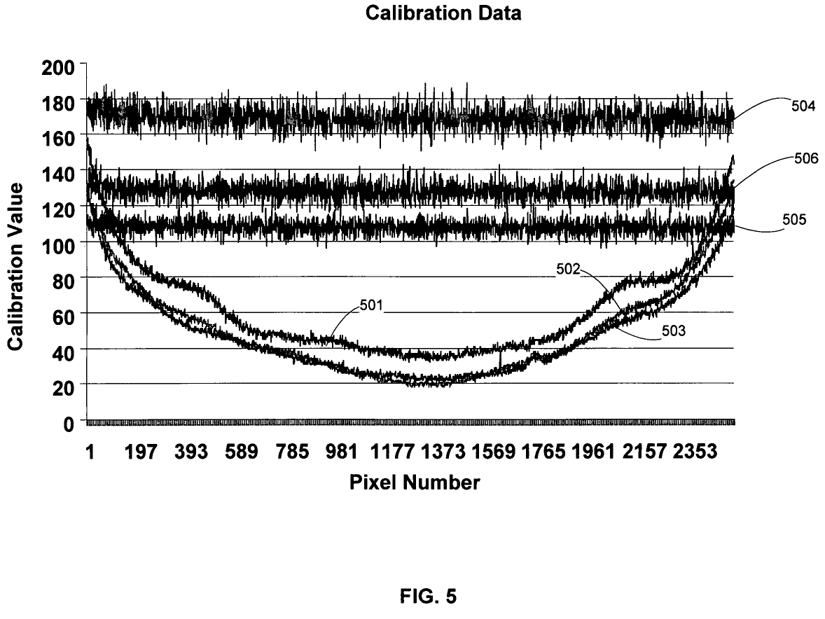

In order to develop a method to reduce the amount of compensation data that must be stored to memory, actual scanner calibration data must first be analyzed. Sample calibration data for a 300-ppi scan is shown in FIG. 5.

Notice that in the example of FIG. 5, in one embodiment the gain values (Red Gain 501, Green Gain 502 and Blue Gain 503) go from as low as 20 to as high as 160, while the offset values go from 150 to 190. While the gain values have a large maximum swing across the line, from one pixel to the adjacent pixel the gain value only has a maximum deviation of about 10. The offset values (Red Offset 504, Green Offset 505 and Blue Offset 506) have a smaller maximum swing across the line, but from pixel-to-pixel the offset is as high as around 30. What can be taken from this data is that the gain may vary widely across the line, but will stay relatively close to its previous value from pixel-to-pixel. The offset values will have a smaller maximum variation, but may vary at its maximum from pixel-to-pixel. Looking at the average deviation from pixel-to-pixel, the gains deviate an average of 1.2 units while the offsets deviate an average of 6 units.

In the preferred embodiment, the calibration data is compressed to store only the deviation from the previous value. The deviation is a signed number with a specified range. Given a starting point, each deviation packet will add or subtract from the previously computed value. As long as the deviation has enough range to cover more than the nominal pixel-to-pixel deviation, the resulting image will be visually equivalent since the calibration data will be nearly identical after it is computed.

In a preferred embodiment, if a value deviates greater than the range provided by the algorithm, then the deviation is maximized and the subsequent error is diffused to the next deviation. This allows an overflow error to occur on one calibration value, with no error for subsequent values. By diffusing the error, the resulting compensation will be visually equivalent.

As an example, consider the data provided in FIG. 5. Given the maximum and average deviation, it would be sufficient to provide a 5-bit deviation value for each offset and gain value. A 5-bit deviation results in a range of (−16 to +15) from pixel-to-pixel. If the starting point for the green offset were specified to be 115, then this value would be applied to pixel 1. For pixel 2, the desired green offset is 109. Thus, the deviation value for pixel 2 will be −6. For pixel 3, the desired green offset is 130. This exceeds the maximum deviation so the deviation is set to 15, which will result in an offset of 124 and an error of 6. For pixel 4, the desired green offset is 120. The deviation is the desired offset for pixel 3, 130, minus the desired offset of pixel 4, 120, minus the error, 6. This results in a deviation of 4 with zero error. Even though pixel 3 had an error of 6 after decompression, pixel 4 has no error. This method allows the data to be significantly reduced by storing pixel-to-pixel deviations but also allows tolerance for out of range deviations.

Consider calibration data that has a nominal deviation that exceeds the range provided by the previous example, (−16 to +15). In a preferred embodiment, the deviation stored can be the same size but also contain a programmable shift that is set for the entire calibration set. To clarify, the deviation data stored would be the value shifted left by the amount programmed. If the shift were programmed to be one, then each deviation value would be multiplied by two (shifted left by one). This would provide a range of (−32 to +31) in increments of two. While the resolution of the deviation has decreased, the range has doubled. When calculating the resulting calibration data, target values that are non-multiples of two will have an error of one (e.g. a deviation of 11 is desired, but only a deviation of 10 or 12 is possible when shifting the value left by one). If the deviation value is shifted left by two, target values that are non-multiples of four will have an error of the value modulo four (value % 4). This error would then be diffused the same way an out-of-range error would be diffused to the next pixel. Again, the result will be visually equivalent.

In a preferred embodiment, a programmable deviation shift exists for all offset values and another programmable deviation shift exists for all gain values. This method addresses the observation that the average offset deviation range may be very different than the average gain deviation range, but the size of the deviation data stored would be the same for both.

If a group of pixels uses approximately the same offset and gain values, then those pixels may use the same offset and gain values for each PRNU and DSNU compensation and produce visually equivalent results. In a preferred embodiment, the resulting offset and gain value can be used multiple times as specified in a repeat-packet field stored in each calibration data packet. If an offset and a gain deviation value is 5 bits each, then for a RGB pixel, 30-bits of calibration data is stored. This data is considered to be part of the calibration data packet. A repeat-packet field will complete the calibration packet. In the hardware implementation, the repeat-packet field is two bits and specifies how many times the resulting offset and gain values will be repeated, zero to three times. This is equivalent to grouping the pixels together in groups of one to four during calibration.

FIG. 6 shows the composition of a calibration packet 601 as implemented in one embodiment. By specifying how to group each set of pixels, dynamic grouping is possible to minimize the calibration data and still account for odd pixel-to-pixel variations. For this implementation, pixels can be grouped into as many as four pixels per resulting calibration. The average offset and gain can be computed for this group, then the resulting data can be compressed using the pixel-to-pixel deviations.

In one embodiment, the numbers in the calibration transformation curve diagram of FIG. 5 are used as follows:

Offset Calculation:
Pixel_With_Offset=Pixel_Uncorrected−(Offset_Value<<Constant)

With reference to the “left shift by constant” step previously described with respect to FIG. 5, since the Pixel_Uncorrected value is 16-bits (corresponding to a 48-bit scanner) full resolution can be obtained while storing/using a 16-bit offset for each pixel. In order to reduce the data that has to be stored, an 8-bit (when it is uncompressed) offset value may be used. The left shift constant is used to place the 8-bit value to correct bit position if needed. The idea is that the black level for Pixel_Uncorrected should be a low value (close to 0). As long as the black level is less than 256 (first least significant 8-bits), then the constant is 0 and this computation is exact. As the black level for Pixel_Uncorrected goes higher, there is more loss in the exactness of the calculation. However, once the pixel is transformed from a 16-bit value to an 8-bit value (three colors make a 24-bit pixel, which is the standard resolution returned by today's scanners), the loss in the calculation will be negligible.

Gain Calculation:
Pixel_With_Gain=Pixel_With_Offset*(Gain_Value+128)/128

In one embodiment, 128 may be used as the constant for calculating the 1.0 to 2.99 gain. An 8-bit (when it is uncompressed) gain value may also be used. So, the maximum gain is (255+128)/128=2.99. The pixel may be multiplied by 1.0 to 2.99 in order to stretch its value up to the white point.

Each pixel may contain an 8-bit offset and an 8-bit gain for each red, green, and blue component of the pixel. Uncompressed, this is 3*(8+8)=48-bits of calibration data per input RGB pixel.

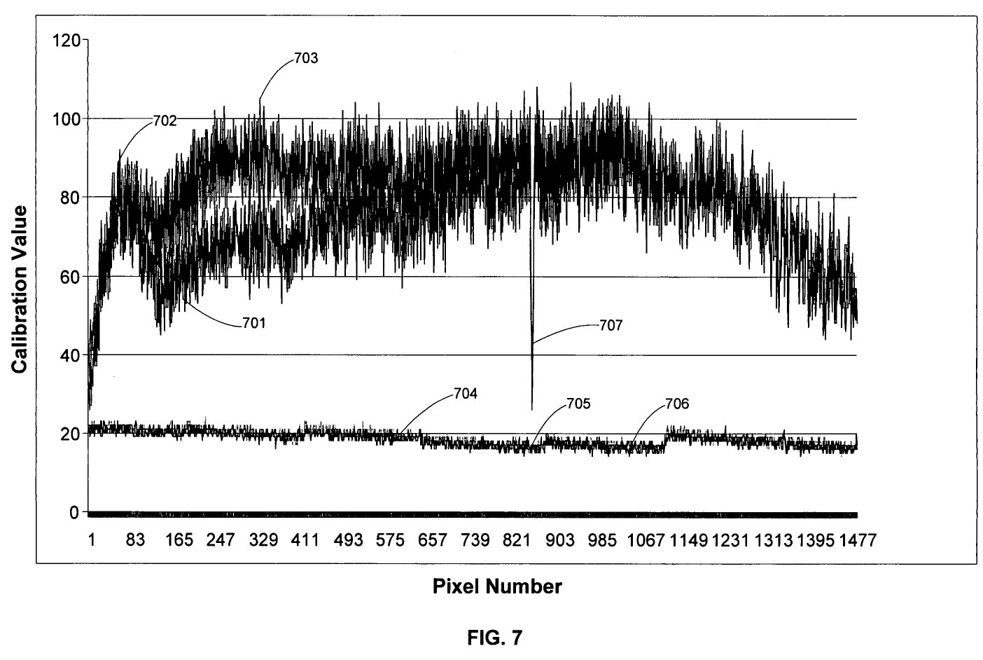

Another example of captured calibration curves is given in FIG. 7. These curves are captured from a CIS scanner. There are three gain curves—red gain curve 701, green gain curve 702, blue gain curve 703—all of which overlap one another. There are three offset curves—red offset curve 704, green offset curve 705 and blue offset curve 706. Again all three offset curves overlap each other. The constant used to compute the offset is 6.

As an example, the offset and gain will be calculated for a pixel using the values in FIG. 7. If the input red pixel is equal to 4660 (16-bit value coming from A/D converter), and this is pixel #100, then the offset value stored is 21 and the gain value stored is 72 (after the calibration data is decompressed). So,
Pixel[100].AfterOffset=Pixel[100].In−(21<<6)=4660−1344=3316.
Pixel[100].Calibrated=Pixel[100].AfterOffset*(72+128)/128=3316*1.5625=5181.

Notice that in FIG. 7, around pixel 860 there is a dead or poorly reacting sensor corresponding to that pixel (at reference point 707 in the figure). The compressed calibration algorithm will contain error when calculating this pixel's offset and gain, but the error will be diffused to the next pixel in order to catch up and become lossless for pixels after 860 or so.

Keep in mind that this is how offset and gain calibration may be performed in one embodiment. The end goal is the same: get the white and black response normalized across the scanned line.

In order to utilize the methodology of the present invention in one embodiment, the flow in FIG. 4 changes according to the teachings of the present invention, as shown in FIG. 8. The offset and gain calibration data must be compressed using the deviation and grouping method and then stored to memory. During compensation, the compressed calibration data must be uncompressed before it is applied to the data.

With reference to FIG. 8, the following steps may be performed in one embodiment in order to implement PRNU and DSNU calibration and compensation flow using compressed calibration data.

Beginning with step 801, the scan begins. In step 802, one or more lines of black data are scanned or one or more lines are scanned with the light off. In step 803, pixel-to-pixel offset data are calculated and stored to memory in step 804. In some cases, a calculation of this offset data is not required as previously explained with respect to this step 403 of FIG. 4. In step 805, one or lines of white data are scanned. In step 806, pixel-to-pixel gain data are computed, and stored to memory in step 808. In step 809, the offset and gain values are retrieved from memory and compressed, and the compressed values are stored back into memory in step 810. In an alternate embodiment to further decrease memory usage, prior to compressing the offset and gain values, a selected number of the highest order bits of the offset and gain data are chosen and then compressed and stored in the memory.

In step 811, a line of the target image is scanned, and in step 812, the compressed offset and gain values are read from memory are decompressed. In step 813 the decompressed pixel-to-pixel offset data is subtracted from the scanned line of the target image. In step 814, pixel-to-pixel multiplication using the decompressed gain data is performed on the scanned line of the target image. In step 815, a PRNU/DSNU compensated scan line results from steps 813 and 814 and is stored in memory or a buffer. The PRNU/DSNU compensated line can also be outputted to a computer or processor connected to the scanner. In step 816 a determination is made to see if the end of the scanned image has been reached. If the scan of the target image is not complete, then the process is repeated beginning at step 811 for each of the remaining lines of the target image. If the scan is complete, the process ends at step 817.

To quantify the amount of reduction in calibration data, consider a traditional offset and gain value of size one byte each for a total of two bytes of calibration data required per color plane per pixel. For a RGB color pixel, this results in six bytes or 48-bits of calibration data per pixel. As shown in a previous calculation, this will require 31 KB of calibration data per scan line. By storing only the deviation for the offset and gain, each offset and gain value can be reduced from 8-bits to 5-bits using the method discussed in this document. If each pixel has one 32-bit calibration packet associated with it (i.e. there are no calibration groups greater than one pixel), then for a 9″ 600-ppi scan line, 21 KB of calibration data would be input per line. This is a 33% reduction in data. If the pixels were on average grouped together to two pixels per calibration packet, then 10.5 KB of calibration data would be input per line. This is a 66% reduction in data. If the pixels were on average grouped together to three pixels per calibration packet, then 7.03 KB of calibration data would be input per line. This is a 78% reduction in data. If the pixels were on average grouped together to four pixels per calibration packet, then 5.27 KB of calibration data would be input per line. This is an 83% reduction in data.

Reductions of this magnitude relieve the memory bandwidth that was previously consumed by the PRNU and DSNU compensation step. It even makes possible the addition of a local buffer to store the calibration data for even greater performance within the cost constraints of a scanner controller ASIC. The calibration data is so small, it would be possible to store the calibration data on a host PC and send it through USB during scan, thus eliminating the requirement for a local memory to store the calibration data in a host based scanner.

Relieving this memory bottleneck improves performance significantly. In one embodiment, for the target ASIC performance model using an average grouping of four pixels per calibration packet, the amount of time to complete a copy operation in high quality copy mode (600×600 ppi scan, 1200×1200 dpi print, 100% coverage) dropped from 23.04 seconds to 21.65 seconds. For normal quality copy mode (300×600 ppi scan, 600×600-dpi print, 40% coverage), the amount of time to complete the copy operation dropped from 9.15 seconds to 8.46 seconds. Even though the entire copy operation is comprised of several modules, all of which require memory bandwidth, relieving the PRNU/DSNU compensation bandwidth requirement has a significant impact on the overall system performance. Of course, it will be understood that the decreases in time to perform the copy operations described above are examples only. The actual decrease in time, and therefore increase in performance, achievable by using the teachings of the present invention will be based upon a number of factors as would be known to those of skill in the art.

An even more important advantage of this method is the impact on the overall memory bandwidth of an all-in-one controller ASIC. If the direct memory access (DMA) block is accessing memory more than 20% of the time while printing, the embedded processor may be unable to read the instructions from memory in time to properly service interrupts that are critical to the system. Using traditional methods, the PRNU/DSNU compensation step may consume so much memory bandwidth that the scan and print speed must be slowed down in order to operate the device correctly. This will have an even greater impact on copy time. Using the method described here, the PRNU/DSNU compensation step has significantly less impact on the overall memory bandwidth consumed. This can make the difference in printing at 30 inches per second (ips) rather than printing at 25 ips. Using the traditional method, six bytes per pixel, the calibration DMA channel alone consumes 1.5% of the 20% budget (a single channel among approximately 40 channels). Using the compressed method with four bytes per pixel, the bandwidth consumed is 1.0514%. At two bytes per pixel, it consumes 0.5257%. At one byte per pixel, it is 0.2629%, an 82% reduction from the traditional method.

The embodiments described above are given as illustrative examples only. It will be readily appreciated by those skilled in the art that many deviations may be made from the specific embodiments disclosed in this specification without departing from the scope of the invention.

We claim:

1. A method for calibrating a scanner with an associated memory, comprising the steps of:
generating offset data for a scan line, and storing the offset data in the memory;
generating gain data for a scan line, and storing the gain data in the memory; and
compressing the offset data and the gain data, and storing the compressed offset data and gain data in the memory.

2. The method of claim 1, further comprising the steps of:
scanning an image line of a target image;
reading the compressed offset data and gain data from the memory;
decompressing the compressed offset data and the gain data; and
applying the decompressed offset data and gain data to the scanned image line of the target image, thereby generating a compensated scan line.

3. The method of claim 2, further comprising the step of:
storing the compensated scan line in the memory.

4. The method of claim 2, further comprising the step of:
outputting the compensated scan line to a computer coupled to the scanner.

5. The method of claim 2, further comprising the step of:
printing the compensated scan line.

6. The method of claim 1, wherein the offset data generating step comprises the steps of:
scanning a line of black data; and
calculating pixel-to-pixel offset data for the scanned line.

7. The method of claim 1, wherein the offset data generating step comprises the steps of:
scanning a line with a light, associated with the scanner, turned off; and
calculating pixel-to-pixel offset data for the scanned line.

8. The method of claim 1, wherein the gain data generating step comprises the steps of:
scanning a line of white data; and
calculating pixel-to-pixel gain data for the scanned line.

9. The method of claim 1, wherein the compressing step is performed by storing the pixel-to-pixel deviations of the offset data and the gain data for pixels comprising the scan line.

10. The method of claim 9, wherein the offset data and the gain data is grouped between pixels.

11. The method of claim 1, wherein any error generated in the compression step is diffused to a neighboring pixel of the scan line.

12. The method of claim 1, wherein only a selected number of the highest order bits of the offset data and gain data are compressed and stored in the memory.

13. A system for calibrating a scanner, comprising:
an image sensor for detecting a calibration scan line comprising a plurality of pixels;
a memory; and
a processor for performing the steps of:
receiving the calibration scan line from the image sensor;
generating offset data for the calibration scan line, and storing the offset data in the memory;
generating gain data for the calibration scan line, and storing the gain data in the memory; and
compressing the offset data and the gain data, and storing the compressed offset data and gain data in the memory.

14. The system of claim 13, wherein the processor further performs the steps of:
scanning an image line of a target image;
reading the compressed offset data and the gain data from the memory;
decompressing the compressed offset data and the gain data; and
applying the decompressed offset data and gain data to the scanned image line of the target image, thereby generating a compensated scan line.

15. The system of claim 14, wherein the processor further performs the step of:
storing the compensated scan line in the memory.

16. The system of claim 14, wherein the processor further performs the step of:
outputting the compensated scan line to a computer coupled to the scanner.

17. The system of claim 14, wherein the processor further performs the step of:
printing the compensated scan line.

18. The system of claim 13, wherein the processor performs the offset data generating step by performing the steps of:
scanning a line of black data; and
calculating pixel-to-pixel offset data for the scanned line.

19. The system of claim 13, wherein the processor performs the offset data generating step by performing the steps of:
scanning a line with a light, associated with the scanner, turned off; and
calculating pixel-to-pixel offset data for the scanned line.

20. The system of claim 13, wherein the processor performs the gain data generating step by performing the steps of:
scanning a line of white data; and
calculating pixel-to-pixel gain data for the scanned line.

21. The system of claim 13, wherein the processor performs the compressing step by storing the pixel-to-pixel deviations of the offset data and the gain data for pixels comprising the scan line.

22. The system of claim 21, wherein the offset data and the gain data is grouped between pixels.

23. The system of claim 13, wherein the processor performs the compressing step by diffusing any error generated to a neighboring pixel of the scan line.

24. The system of claim 13, wherein the processor only compresses and stores in the memory a selected number of the highest order bits of the offset data and gain data.
